(19) United States
(12) Patent Application Publication
(10) Pub. No.: US 2009/0156743 A1
(43) Pub. Date: Jun. 18, 2009

(54) METHOD FOR NUCLEATING POLYMERS

(75) Inventors: Nissim Garti, Jerusalem (IL); Abraham Aserin, Jerusalem (IL); Dima Libster, Jerusalem (IL)

Correspondence Address: BROOKS KUSHMAN P.C., 1000 TOWN CENTER, TWENTY-SECOND FLOOR, SOUTHFIELD, MI, 48075, US

(73) Assignee: Yissum Research Development Company of the Hebrew University of Jerusalem, Jerusalem (IL)

(21) Appl. No.: 12/280,910

(22) PCT Filed: Feb. 27, 2007
(86) PCT No.: PCT/IL07/00263

§ 371 Date: Dec. 2, 2008

Related U.S. Application Data
(60) Provisional application No. 60/776,691, filed on Feb. 27, 2006.

(51) Int. Cl. C08L 53/02; C09K 3/00; C08L 75/04; C08L 53/00

(52) U.S. Cl. 525/98; 252/182.11; 252/182.13; 252/182.3; 252/182.23; 252/182.28; 252/182.14; 252/182.32; 252/182.18; 525/123; 525/95

(57) ABSTRACT

The present invention discloses a nucleating microemulsion comprising nanovehicles, each comprising an amphiphilic shell surrounding a nucleating agent. The microemulsion is suitable for the delivery of the nucleating agents into a thermoplastic polymer, thereby allowing crystallization of the polymer.

### FIELD OF THE INVENTION

This invention relates to methods and formulations which allow, e.g., high nucleation rates of polymers, particularly thermoplastic polymers.

### BACKGROUND OF THE INVENTION

Crystallization of polymers is a process which is responsible to the formation of a new crystalline phase. It occurs within the cooling polymer at the so-called nuclei upon lowering the polymer's temperature below its melting temperature. This process consists of several stages of nucleation and growth.

There are essentially two major types of nucleation in polymers: homogeneous and heterogeneous. The homogeneous nucleation which is characterized by a constant rate of nucleation stems from statistical fluctuations of the polymer chains in the melt. The heterogeneous nucleation, on the other hand, is characterized by a variable rate and a relatively low super-cooling temperature. This occurs in the presence of foreign bodies which are present in the polymer melt and which increase the rate of crystallization, acting as alien heterogeneous nuclei and reducing the free energy for the formation of a critical nucleus.

These foreign minor additives are called nucleating agents or nucleators. Such materials cause higher polymer crystallization temperatures, thereby increasing the number of spherulites present in the cooling polymer melt and improving the optical and mechanical properties of the resulting polymer. Due to the higher polymer crystallization temperatures, one can significantly reduce crystallization cycle times and raise output.

Various materials have been tested as possible candidates for nucleating agents for crystallization of thermoplastic polymers, such as polypropylene (PP). The most common nucleators are aromatic carboxylic acid salts, like sodium benzoate. Talc and other inorganic fillers are also suitable nucleators. While they are inexpensive and may also serve as reinforcing agents, their nucleating efficiency is limited and their ability to reduce haze is poor.

Sorbitol based nucleators provide significant improvement over conventional nucleating agents both in nucleating efficiency and clarity. Unlike the dispersion type nucleators, they dissolve in the molten PP and disperse uniformly in the matrix. When the PP cools, the nucleator first crystallizes in the form of a three-dimensional fibrillar network of nanometric dimensions. The fibrils serve as nucleating sites for PP, probably due to epitaxial growth. The most common examples of this type of nucleators are 1,2,3,4-bis-dibenzylidene sorbitol, DBS, and 1,2,3,4-bis-(p-methoxybenzylidene sorbitol). The major drawback of DBS is its fast evaporation rate during processing. Modified structures of DBS such as 1,2,3,4-bis-(p-methylbenzylidene sorbitol), MBDS, and 1,2,3,4-bis-(3,4-dimethylbenzylidene sorbitol) have been developed to solve this problem and improve the nucleating efficiency.

Sodium 2,2′-methylene-bis-(4,6-di-tert-butylphenyl) phosphate known as NA-11 is another example of a powerful nucleator, which shows a significant effect even at low concentrations. Bicyclo[2.2.1]heptane dicarboxylate salt (HPN-68) is among the recently developed nucleators, known to improve the crystallization rates of PP polymers with certain enhancement of the modulus of the articles produced.

International Publication No. WO 2005/040259 discloses nucleating additive formulations consisting of solid bicyclo[2.2.1]heptane dicarboxylate salts and further comprising at least one anticaking agent for haze reduction, improved nucleation performance, and prevention of potential cementation. The formulation is provided in small non-capsule particles which provide desirable properties within thermoplastic articles, particularly as nucleating agents.

U.S. Pat. No. 7,129,323 to Burkhart et al., discloses specific methods of inducing high nucleation rates in thermoplastics, such as polyolefins through the introduction of two different compounds that are substantially soluble within the target molten thermoplastic polymer. Such introduced components react to form a nucleating agent in-situ within such a target molten thermoplastic polymer which is then allowed to cool. Preferably, one compound is bicyclo[2.2.1]heptane dicarboxylic acid or hexahydrophthalic acid, and the other compound is an organic salt, such as a carboxylate, sulfonate, phosphate, oxalate, and the like, and more preferably selected from the group consisting of metal C₈-C₂₂ esters. This method is said to provide a manner of generating in-situ the desired nucleating agent through reaction of such soluble compounds.

International Publication No. WO 2003/040230 discloses compounds and compositions comprising specific metal salts of bicyclo[2.2.1]heptane dicarboxylate salts. The salts and derivatives are said to be useful as nucleating and/or clarifying agents for such polyolefins, provide excellent crystallization temperatures, stiffness, and calcium stearate compatibility within target polyolefin. Additionally, such compounds are said to exhibit very low hygroscopicity and therefore to have excellent shelf stability as powdered or granular formulations.

Thermoplastic polymers consist of polymeric material that will melt upon exposure to sufficient heat, retain its solidified state, but not its prior shape unless a mold is used upon cooling. Thermoplastics have been utilized in a variety of end-use applications, including storage containers, medical devices, food packages, plastic tubes and pipes, shelving units, and the like. Such base compositions, however, must exhibit certain physical characteristics in order to permit widespread use. Specifically within polyolefins, for example, uniformity in arrangement of crystals upon crystallization is a necessity to provide an effective, durable, and versatile polyolefin article. In order to achieve such desirable physical properties, nucleating agents have been utilized.

Microemulsions are optically isotropic and are thermodynamically stable mixtures of water, oil, and amphiphile(s). Microemulsions usually contain co-solvents or co-surfactants in order to achieve low interfacial tension and the packing parameters required. Upon water dilution, three major structural domains can be distinguished: water-in-oil (W/O), bicontinuous, and oil-in-water (O/W). Microemulsions require minimal effort for their formation, and once formed they have exceptional long-term thermodynamic stability. Furthermore, they are capable of solubilizing significant amounts of water-soluble or oil-soluble compounds and so have been extensively used in many applications such as cosmetics, foods, pharmaceuticals, and in some industrial applications.

International Publication NO. WO 2003/105607 discloses nano-sized self-assembled structured concentrates and their use as carriers of active materials, particularly liphophilic compounds suitable for pharmaceutical or cosmetic applications or as a food additive.

### LIST OF PUBLICATIONS

[a] WO 2005/040259
[b] U.S. Pat. No. 7,129,323
[c] WO 2003/040230
[d] WO 2003/105607
[e] M. Teubner and R. Strey, J. Chem. Phys. 87 (1987), p. 3195
[f] B. Fillon et al., Polym. Sci. Part B Polym. Phys. 31 (1993), p. 1383
[g] B. Fillon et al., J Polym. Sci. Part B Polym. Phys. 31 (1993), p. 1395
[h] J. Li et al., Polym. Testing 21 (2002), p. 583
[i] A. Turner-Jones, Polymer 12 (1971), p. 487

### SUMMARY OF THE INVENTION

One of the problems encountered with standard thermoplastic polymer nucleators is inconsistent nucleation due to inhomogenous dispersion. Any inhomogeneity of dispersion typically results in modulus and impact variations along the polymer in the final polymeric article. It is typical to find under such circumstances polymeric articles which are at one part thereof brittle and on the other part stiff and impact resistant.

Another problem, which is common to nucleators for industrial applications, is associated with the need for additives which are necessary in order to avoid caking or cementing of the nucleator composition prior to use and/or during storage. The usage of such additives is not only costly and at times a complexing factor in formulating the polymer-nucleator blends but also may introduce into the final polymeric article agents which can impart deleterious nucleating efficacy.

The present invention is based on the finding that the problems briefly described above, mainly those associated with the dispersion of the nucleator in the thermoplastic polymer, may be minimized or completely diminished by dispersing a microemulsion of nanovehicles comprising the nucleator molecules into the target molten polymer. The use of said microemulsion provides better dispersion of the nucleator in the thermoplastic polymer, thereby imparting to the polymer the improved characteristics such as:
(1) dense and more homogenous packing of small spherulites in the thermoplastic polymer;
(2) higher polymer crystallization temperatures;
(3) higher nucleation rates even with low concentrations of the nucleator;
(4) lower melting points of the thermoplastic article;
(5) lower haze of the thermoplastic article; and
(6) increased isotropicity of the final thermoplastic article.

Thus, in one aspect of the present invention, there is provided a nucleating microemulsion comprising a plurality of nanovehicles, each having an amphiphilic shell substantially surrounding at least one nucleator.

In the context of the present invention, the term “microemulsion”, as known to a person skilled in the art, refers to an optically isotropic (clear) and thermodynamically stable liquid solution of oil and water containing domains, e.g., micelles, of nanometer dimensions, herein referred to as “nanovehicles”, stabilized by a shell, i.e., interfacial film, of at least one amphiphile. Without wishing to be bound by theory, in such ternary systems, where two immiscible phases, e.g., oil and water, are mixed with the an amphiphile, the amphiphile molecules form a monolayer at the interface between the oil and water domains, with the hydrophobic tails of the amphiphile molecules embedded in the oil phase and the hydrophilic head groups in the aqueous phase.

The term “nucleating microemulsion” refers to a microemulsion which comprises a plurality of nucleator-containing nanovehicles. The nucleating microemulsion of the invention is capable of bringing about the nucleation of polymers, particularly thermoplastic polymers.

The nanovehicles of the invention are characterized as having a micelle like core-shell structure, i.e., a structure consisting of a core containing material, and a shell which substantially surrounds it. The term “substantially surrounding at least one nucleator” relates to the relative location of the amphiphile molecules (the shell) with respect to the nucleator molecules. The nucleator may reside in the core of the nanovehicle, between the amphiphilic molecules forming the shell or on the outer perimeter of the shell. This relates to the ability of the plurality of nanovehicles of the microemulsion to effectively solubilize the at least one nucleator. The residence of the plurality of nucleators at any point of time may be in one or more of these locations and may depend on a number of different effects, such as the hydrophobicity or hydrophilicity of the nucleator molecule towards the microemulsion media, the ability of the nucleator molecules to diffuse into or outwards of the core, the degree or rate of such diffusion, the concentration of the nucleator, the density of the nanovehicles in the microemulsion, the presence of one or more additives, and the nature of the amphiphile.

The nanovehicles of the invention are further characterized as having cross-sectional average diameters on the nanometer scale. In one embodiment, the average diameter of the nanovehicle is from 1 nanometer (nm) to 1,000 nm. In another embodiment, the average diameter is between 1 nm and 100 nm. In still another embodiment, the average diameter is between 5 nm and 20 nm.

As may be understood, the microemulsion of the invention may comprise any number of nanovehicles. Thus, the term “plurality” generally refers to any number of the nanovehicles being typically greater than 1. In some embodiments, the microemulsion may comprise a first plurality of nanovehicles according to the invention and a second plurality of nanovehicles prepared according to a different method than that which is disclosed herein. In one embodiment, the second plurality of nanovehicles is prepared by a method being a modification of the method disclosed herein, i.e., a method which utilizes a different nucleator or a different amphiphile. In another embodiment, the second plurality of nanovehicles is prepared also according to the method of the invention but comprises a nucleator (or a combination of nucleators) which is different from the nucleator used in said first plurality of nanovehicles.

The “nucleator” or nucleating material is art known, and refers to an agent which is capable of reducing the time required for onset of crystallization of a thermoplastic polymer upon cooling from the melt. According to the present invention, the nucleator may be hydrophilic or hydrophobic in nature.

In one embodiment of the present invention, the nucleator is selected amongst metal salts of organic acids or phosphonic acids.

In another embodiment, the metal salts of organic acid nucleators are selected amongst salts of benzoic acid (e.g., sodium benzoate) and alkyl substituted benzoic acid derivatives, bicyclo [2.2.1]heptane dicarboxylate salt, 1,3-O-2,4-bis(3,4-dimethylbenzylidene) sorbitol, (3,4-DMDBS), 1,3-O-2,4-bis(p-methylbenzylidene) sorbitol, (p-MDBS), sodium 2,2′-methylene-bis-(4,6-di-tert-butylphenyl)phosphate, and aluminum bis[2,2′-methylene-bis-(4,6-di-tert-butylphenyl)phosphate] with lithium myristate.

In one preferred embodiment, the at least one hydrophilic nucleator is bicyclo [2.2.1]heptane dicarboxylate salt (also known as HPN-68).

In another embodiment, the at least one nucleator is a combination of two or more nucleators. The combination may, for example, be of two or more different salts of the same nucleator, for example a combination of an aluminum salt of benzoic acid and a copper salt of benzoic acid. In another example, the combination is of two different nucleators, one being for instance a salt of benzoic acid and the other HPN-68.

In the context of the present invention the terms “amphiphile”, “amphiphilic” or any lingual variation thereof, are known to a person skilled in the art and generally refer to a compound possessing both hydrophilic and hydrophobic properties. The amphiphilic shell surrounds the core, having either an inner lipophilic core or an inner hydrophilic core, depending on the nature of the core material, the system solubilizing the core material, and other characteristics of the core-shell system.

An amphiphilic compound as used in the present invention may be a surfactant (ionic or non-ionic) or any other amphiphilic compound not traditionally classified as a surfactant but which is capable of lowering the surface tension between the two phases of the microemulsion, thereby allowing easier spreading of one phase in the other.

In one embodiment, said amphiphlic shell comprises at least one amphiphile. In another embodiment, the amphiphilic shell comprises two or more amphiphiles.

In another embodiment, said surfactant is a nonionic surfactant, preferably having a hydrophilic-liphophilic balance (HLB) value in the range of 9-16.

In another embodiment, said at least one surfactant is selected amongst ethoxylated alcohols, acids, amines, sorbitan esters, monoglycerides, polyglycerol esters (mono- to deca-glycerol and mono- to deca-fatty acids), sugar esters, phospholipids (such as lecithins), and ethoxylated nonyl and alkyl phenols.

Non-limiting examples of amphiphilic compounds are sodium dodecyl sulphate (anionic), benzalkonium chloride (cationic), cocamidopropyl betaine (zwitterionic), octanol (long chain alcohol, non-ionic), polyoxyethylene-20-sorbitan monostearate (Tween 60), polyoxyethylene-20-sorbitan monooleate (Tween 80), polyoxyethylene-20-sorbitan monolaurate (Tween 20), polyoxyethylene-20-sorbitan monomyristate (Tween 40), polyoxyethylene-9 nonyl phenol ether, polyoxyethylene-12-nonyl phenol ether, polyoxyethylene-15-nonyl phenol ether, ethoxylated-10-lauryl alcohol, ethoxylated-20-oleyl alcohol, ethoxylated-15-stearyl alcohol, ethoxylated-20-castor oil, hydrogenated ethoxylated-25-castor oil, and combinations thereof.

In one embodiment, the at least one amphiphile is selected from polyoxyethylene-20-sorbitan monostearate (Tween 60), polyoxyethylene-20-sorbitan monooleate (Tween 80), polyoxyethylene-20-sorbitan monolaurate (Tween 20), polyoxyethylene-20-sorbitan monomyristate (Tween 40).

In another embodiment, the at least one amphiphile is polyoxyethylene-20-sorbitan monostearate (Tween 60).

In another preferred embodiment, the at least one hydrophilic nucleator is bicyclo [2.2.1]heptane dicarboxylate salt (HPN-68) and the at least one amphiphile is polyoxyethylene-20-sorbitan monostearate (Tween 60). The microemulsion of the invention may further comprise at least one additive selected amongst co-solvents, co-surfactants, colorants, pigments, perfumes, carbon black, glass fibers, fillers, impact modifiers, antioxidants, stabilizers, flame retardants, reheat aids, anticaking agents, antistatic agents, ultraviolet absorbers, acetaldehyde reducing compounds, acid scavengers, antimicrobials, light stabilizers, recycling release aids, plasticizers, mold release agents, compatibilizers, and the like, or their combinations.

The at least one additive or a combination of two or more of such additives may be added in conventional amounts directly to the reaction mixture containing the molten polymer prior to cooling or together with the nucleator when preparing the microemulsion.

The at least one additive may be added in any form suitable for the particular application, e.g., as a powder, in the form of fine granules, as a solution in an appropriate solvent, contained with the nucleator within the core or embedded within the shell, in different nanovehicles, etc.

As stated above, the nucleator is solubilized in a system of water, oil, alcohol and at least one amphiphile. In one embodiment, said oil is selected amongst water-immiscble liquids such as mineral oil, paraffin oil, xylene, toluene, petroleum ether, hexanes, decalin, isopropylmyristate, medium chain triglycerides, dodecane, tetradecane, and hexadecane.

In another embodiment, said oil is paraffin oil.

In another embodiment, said oil is a liquid mineral oil in the work region of temperature 10-120° C.

In yet another embodiment, the oil is Marcol 52 (commercially available from Paz Lubricants and Chemicals, Ltd, Haifa, Israel).

In another preferred embodiment, the at least one hydrophilic nucleator is bicyclo [2.2.1]heptane dicarboxylate salt (HPN-68) and the at least one oil is Marcol 52.

In another preferred embodiment, the at least one hydrophilic nucleator is bicyclo [2.2.1]heptane dicarboxylate salt (HPN-68), the at least one amphiphile is polyoxyethylene-20-sorbitan monostearate (Tween 60) and the at least one oil is Marcol 52.

In another embodiment of the invention, said alcohol may be selected amongst the following non-limiting examples: pentanol, butanol, octanol, decanol, hexylene glycol, propylene glycol, isopropanol, propanol, dodecanol, 1-heptanol, 2-heptanol, 3-heptanol, 2-hexanol, 3-hexanol, 1-methylbutanol, 1-methylpentanol, 1-methylhexanol, 1-methylheptanolanol, 4-ethyl-1-propanol, 2 methylbutanol, 3-methylhexanol, 2-methylpentanol, cyclohexanol and derivatives or combinations thereof.

Preferably, said alcohol is 1-hexanol.

In another embodiment, said nucleating microemulsion is suitable for the delivery of said at least one nucleator into a thermoplastic polymer. Generally, the nucleator is chosen to be chemically inert with respect to the thermoplastic polymer in the melt or after cooling.

The term “thermoplastic polymer” refers in its broadest definition to a polymeric material or to a blend of such materials that deforms or melts to a liquid (the so-called molten state) when heated and freezes to a brittle, glassy state when cooled sufficiently. The polymeric chains of most thermoplastic polymers are associated through weak van der Waals forces; stronger dipole-dipole interactions and hydrogen bonding; or even stacking of aromatic rings. An isotropic thermoplastic polymer is one which has uniform characteristics throughout; such may be dispersive, physical and/or chemical characteristics, as further exemplified hereinbelow.

In one embodiment, the thermoplastic polymer is a polyolefin. The “polyolefin” encompasses any compound having two or more olefinic bonds and any material comprising at least one polyolefin compound. Non-limiting examples of polyolefins include functionalized or non-functionalized polypropylene, isotactic or syndiotactic polypropylene, functionalized or non-functionalized polyethylene, functionalized or non-functionalized styrenic block copolymers, styrene butadiene copolymers, ethylene ionomers, styrenic block ionomers, polyurethanes, polyesters, polycarbonate, polystyrene, low density polyethylene (LDPE), linear low density polyethylene (LLDPE), medium density polyethylene (MDPE), high density polyethylene (HDPE), and polypropylene (PP), polyamides such as poly(m-xyleneadipamide), poly (hexamethylenesebacamide), poly(hexamethyleneadipamide) and poly(epsilon-caprolactam), polyacrylonitriles, polyesters such as poly(ethylene terephthalate), polylactic acid (PLA), polycaprolactone (PCL) and other aliphatic or aromatic compostable or degradable polyesters, alkenyl aromatic polymers such as polystyrene, and mixtures or copolymers thereof.

Other polymers suitable for use in the methods of the invention include ethylene vinyl alcohol copolymers, ethylene vinyl acetate copolymers, polyesters grafted with maleic anhydride, polyvinylidene chloride (PVdC), aliphatic polyketone, LCP (liquid crystalline polymers), ethylene methyl acrylate copolymer, ethylene-norbornene copolymers, polymethylpentene, ethylene acrylic acid copoloymer, and mixtures or copolymers thereof.

Although the preferred thermoplastic polymers are polyolefins, the nucleating method of the present invention is also beneficial in improving the crystallization properties of polyesters such as polyethylene terephthalate, polybutylene terephthalate, and polyethylene naphthalate, as well as polyamides such as Nylon 6, Nylon 6,6, and others.

In one embodiment, the thermoplastic polymer is polypropylene (PP) or a derivative thereof, as may be known to a person skilled in the art.

In another embodiment, the thermoplastic polymer is a copolymer of two different polymers.

In one embodiment, the thermoplastic polymer is a copolymer of PP and polypropylene.

In another embodiment, the thermoplastic polymer is a copolymer of PP and monomeric ethylene.

In another aspect of the invention, there is provided a nanovehicle comprising an amphiphilic shell and at least one nucleator.

In a further aspect, the invention provides a nanovehicle for delivering a nucleator comprising at least one solubilized nucleator, as detailed herein, in a system of water, oil, alcohol and at least one amphiphile.

In another aspect, the invention provides a method for crystallization of a thermoplastic polymer comprising dispersing a nucleating microemulsion of a plurality of nanovehicles in a thermoplastic polymer at the molten state, wherein each of said plurality of nanovehicles comprises at least one nucleator.

The “crystallization of a thermoplastic polymer” is a process known to a person skilled in the art. It typically involves the creation of nucleation sites within the amorphous phase in the molten state, followed by crystal formation during the cooling period of the polymer. Within the context of the present invention, the term also refers to the process of inducing crystallization of the polymer from the molten state, enhancing the initiation of polymer crystallization sites, speeding up the crystallization of the polymer, increasing the effectiveness of nucleation sites, increasing crystallization rate, increasing crystal propagation, and enhancing crystallization relative to crystallization using non-capsulated nucleators.

The dispersion of the plurality of nanovehicles in the polymer is typically achieved by mixing the polymer and the nucleating microemulsion above the melting temperature of the polymer or prior to heating. The mixing may be achieved by any method known in the art. Preferably, the mixing is achieved in a suitable mixer equipped with a mixing tool.

In yet a further aspect, the invention provides a method of increasing the nucleation efficiency of a thermoplastic polymer comprising dispersing a nucleating microemulsion of a plurality of nanovehicles in a thermoplastic polymer at the molten state, wherein each of said plurality of nanovehicles comprises at least one nucleator solubilized in a system of water, oil, alcohol and at least one amphiphile. The ability of the microemulsion of the invention to increase the nucleation efficacy of the polymer is measured as disclosed hereinbelow.

The nucleating microemulsion is preferably added to the molten polymer in an amount which is sufficient to provide the aforementioned beneficial characteristics. Typically, the microemulsion is added within the polyolefin in such an amount to achieve a nucleator concentration which is sufficient to cause nucleation and the onset of crystallization in the polymer in a reduced time compared to, e.g., compositions employing bare nucleator (not in a nanovehicles).

In one embodiment, the amount of nucleator added is between about 20 ppm to about 200 ppm, more preferably is about 20 ppm to about 100 ppm, and most preferably is from 20 ppm to 50 ppm. As will be shown below, these amounts are significantly lower than the amounts of bare nucleator which would be needed to achieve the same effects.

In another aspect of the invention, there is provided a method for preparing a nucleating microemulsion having a plurality of nanovehicles, said method comprising:

i. obtaining a microemulsion of a plurality of nanovehicles each having an amphiphatic shell, and

ii. admixing into said microemulsion at least one nucleator, thereby obtaining the nucleating microemulsion of the invention, namely that having a plurality of nanovehicles, each comprising at least one nucleator in an amphiphatic shell.

The microemulsion containing the plurality of nanovehicles is a single-phase microemulsion which may be a water-in oil solution, bicontinuous or an oil-in-water solution. As a function of the ternary system, one may achieve a two-phase or a single-phase microemulsion, the boundaries of which are stable phases and depend on the relative concentration of each of the ternary components. As will be described herein below the single-phase system is capable of solubilizing the nucleators.

In a further aspect of the invention, there is provided a method of producing an isotropic thermoplastic polymer comprising:

i. dispersing a nucleating microemulsion of a plurality of nanovehicles in a thermoplastic polymer at the molten state; and

ii. cooling the resulting molten thermoplastic polymer, thereby obtaining the isotropic thermoplastic polymer;

wherein each of said plurality of nanovehicles of step (i) comprises at least one nucleator solubilized in a system of water, oil, alcohol and at least one amphiphile.

In one embodiment, the dispersion of the nucleating microemulsion in the thermoplastic polymer is achieved by adding the microemulsion into a pre-molten thermoplastic polymer with mixing.

In another embodiment, the nucleating microemulsion is first blended with the polymeric beads and than heated while mixed to achieve melting of the polymer.

The cooling of the resulting molten thermoplastic polymer is to a temperature below its melting temperature and may be chosen at the discretion of the person carrying out the process. The temperature may for example be a temperature below which the polymer solidifies (T_{g}), or a temperature at which further molding or manipulation of the polymer may be achieved.

In yet a further aspect, the present invention provides a thermoplastic article obtained by a method of crystallization of at least one thermoplastic polymer, said method comprises:

i. dispersing a nucleating microemulsion of a plurality of nanovehicles in a thermoplastic polymer at the molten state; and

ii. cooling the resulting molten thermoplastic polymer;

iii. optionally molding the resulting thermoplastic polymer into a desired shape;

wherein each of said plurality of nanovehicles of step (i) comprises at least one nucleator solubilized in a system of water, oil, alcohol and at least one amphiphile.

In the context of the present invention the term “mold” or “molding” refers to the structural modification of the thermoplastic polymer after it has been cooled to the desired temperature or to the formation of a new structure which is different from the initial structure of the polymer after cooling. The molding may be achieved by any molding technique known to a person skilled in the art, including, without limitations, blow molding, compression molding, injection molding, injection blow molding injection stretch blow molding, injection rotational molding, thin wall injection molding, extrusion techniques such as extrusion blow molding, sheet extrusion, film extrusion, and cast film extrusion, and thermoforming such as into films, blown-films, and biaxially oriented films.

The molding may or may not be necessary depending on the desired structure of the thermoplastic article. In cases where molding is needed, for example, in the manufacture of complex-structured articles, the molded articles made from the polymers of the invention can be made by simply casting into pre-made open-faced molds. Steel, nickel or aluminum metal molds can be created by spray metal forming, electroforming, casting or machining. Other typical rigid molds which may be employed in molding the articles include plaster, rigid urethanes, epoxides and fiberglass. Articles molded or otherwise manufactured from the polymers of the invention typically release well from a variety of mold surfaces and generally do not require the use of release agents.

Generally, the thermoplastic article may take on any shape desired such as sheets, boards, films, fibers, thin film or thin-walled articles, pliable wrappers, and finished products such as trays, containers, bags, sleeves, bottles, cups, bowls, plates, storage-ware, dinnerware, cookware, syringes, labware, medical equipment, pipes, tubes, intravenous bags, waste containers, office storage articles, desk storage articles, disposable packaging, reheatable food containers, toys, sporting goods, recycled articles and the like.

Where necessary, the final shape of the article may also be achieved by other means such as cutting, layering, breaking, shredding, gluing, and coating. The article thus obtained may optionally be further molded and re-molded to achieve the desired shape.

The invention, thus, further provides a thermoplastic polymer or article prepared by using the microemulsion, nanovehicles or any one method of the invention.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1 shows the phase diagram and dilution line of a system composed of: Marcol-52 (mineral oil)/1-hexanol (2:1 wt/wt) as the oil phase, Tween 60 as the emulsifier, and water at 25° C. Dilution line 82 is of 80 wt % surfactant and 20 wt % oil phase;

FIG. 2 shows the total solubilization capacity of the microemulsion. The amount of maximum solubilized HPN-68 (wt %) of total microemulsion+HPN-68 is plotted against the water content, along dilution line 82 at 25° C.;

FIG. 3 shows the O/W droplets diameter (nm) as a function of the water content along dilution line 82. Systems: □—empty microemulsion; ▪—loaded microemulsion with 5 wt % HPN-68;

FIG. 4 shows the microemulsion periodicity, d, as a function of the water content along dilution line 82. Systems: □—empty microemulsion; ▪—microemulsion loaded with the maximum amount of solubilized HPN-68;

FIG. 5 provides the crystallization temperature, T_{c}, of the PP as a function of the content of the nucleating agent and the microemulsion. The microemulsion formulation contain 50 wt % water (dilution line 82) and 0.96 wt % HPN-68. The amount of microemulsion (ME in wt %) of the total microemulsion+PP is indicated at each point. The DSC scanning rate is 10° C./min. Systems: ▪—nucleated HPN-68, □—non-nucleated HPN-68;

FIG. 6 provides the crystallization temperature, T_{c}, of the PP as a function of the cooling rate. Systems: Δ—pure PP, □—PP nucleated with 600 ppm HPN-68 via powder, ▪—PP nucleated with 250 ppm HPN-68 via microemulsion. The microemulsion formulation contained 50 wt % water (dilution line 82). The amount of microemulsion (wt %) of the total microemulsion+PP is 3 wt %;

FIG. 7 provides determination of the effective activation energy (ΔE), describing the overall crystallization process for PP samples, based on the Kissinger method. Systems: Δ—pure PP, □—PP nucleated with 600 ppm HPN-68 via powder, ▪—PP nucleated with 250 ppm HPN-68 via microemulsion. The microemulsion formulation contained 50 wt % water (dilution line 82). The amount of microemulsion (wt %) of the total microemulsion+PP is 3 wt %;

FIGS. 8A-8C show the WAXS diffractograms for (A) pure PP, (B) PP nucleated with 600 ppm HPN-68 via powder, (C) PP nucleated with 250 ppm HPN-68 via microemulsion.

FIG. 9 is a representation of the self-diffusion coefficients of the components of the empty microemulsion calculated from PGSE-NMR as a function of aqueous phase content along dilution line 82. Systems: ▪—water; ⋄—1-hexanol; ▴—mineral oil (Marcol 52); □—Tween 60.

FIG. 10 shows the relative self-diffusion coefficients of water and mineral oil (Marcol 52) calculated from PGSE-NMR as a function of aqueous phase content along dilution line 82 of empty microemulsion. Systems: ▪—water; ▴—mineral oil.

FIG. 11A-11B shows the self-diffusion coefficients of the components loaded with HPN-68 microemulsion calculated from PGSE-NMR as a function of aqueous phase content along dilution line 82 (FIG. 11A). The water content corresponds to the empty microemulsion before the loading of HPN-68. Systems: ▪—water; ⋄—1-hexanol; ▴—mineral oil (Marcol 52); □—Tween 60. FIG. 11B shows the relative self-diffusion coefficients of water in empty microemulsion and microemulsion loaded with BPN-68 microemulsions calculated from PGSE-NMR along dilution line 82. Note that the water content corresponds to the empty microemulsion before loading the HPN-68. □—water in empty microemulsion; ▪—water in microemulsion loaded with the maximum amount of solubilized HPN-68.

FIG. 12 shows the viscosity as a function of the aqueous phase content along dilution line 82 of empty and loaded with HPN-68 microemulsions at 25° C. Note that the water content corresponds to the empty microemulsion before the loading of HPN-68. Systems: □—empty microemulsion; ▪—microemulsion loaded with the maximum amount of solubilized HPN-68.

### DETAILED DESCRIPTION OF EXEMPLARY EMBODIMENTS

As noted above, in order to provide a nucleator composition for industrial applications, one of the criteria needed to be met is that the nucleating agent has to be well dispersed in the polymer. This invention provides a new method of dispersion of a nucleating agent in a polymeric matrix.

The following exemplary embodiments of the invention make use of the term surfactant, however the invention encompasses within its scope all suitable amphiphiles capable of achieving the microemulsions of the invention and in addition capable of dispersing the microemulsions of the invention into the thermoplastic polymer. It should, therefore, be understood by a person versed in the art that the surfactant exemplified may be replaced by any amphiphile with 9-16 HLB values, preferably 13-16 (like Tween 60, Tween 80, and NP9) as disclosed above.

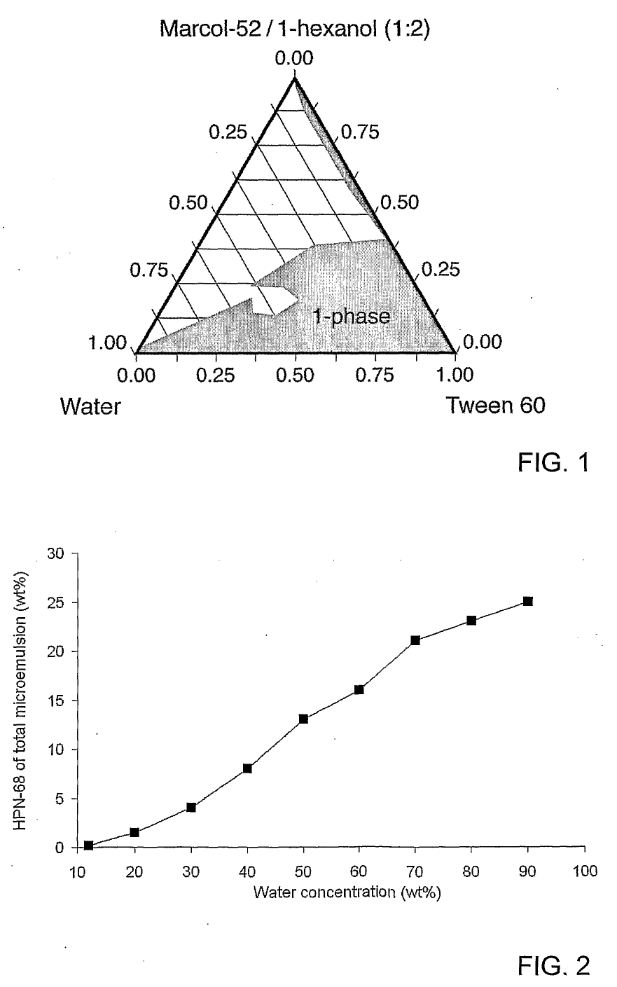

FIG. 1 shows a phase diagram of a microemulsion where the nucleating agent bicyclo [2.2.1]heptane dicarboxylate salt (HPN-68, produced by Millilcen) can be dispersed. The phase diagram contains mineral oil, 1-hexanol (co-solvent), surfactant, and water, in which a clear isotropic microemulsion system can be distinguished. In order to decrease the nucleator size from micrometers to several nanometers it was solubilized along dilution line 82. This line is composed of 80 wt % surfactant and 20 wt % oil phase. Maximum solubilization values of the nucleator, as a function of water content, are presented in FIG. 2. HPN-68 solubilization increases with addition of water and a maximum of 25 wt % can be reached at 90 wt % water content, compared with 0 wt % in the surfactant phase only. Without wishing to be bound by theory, the surfactant serves as a vehicle for the nucleator in the polymer melt. Therefore, its solubilization in the microemulsion allows decreasing its size before introduction to the polymer matrix, which is impossible using the surfactant alone. HPN-68 consists of two major groups: the polar head which supplies nucleator transport ability in the matrix and the hydrophobic group providing the wetting ability between the BPN-68 and the PP. If properly chosen for a specific matrix, the surfactant should improve the HPN-68 mobility in this matrix.

To gain information concerning the size of the microstructure, Dynamic Light Scattering analysis [DLS] of empty and loaded nanovehicles in the microemulsions were carried out at 87-99 wt % aqueous phase. The measurements were performed only in oil-in-water (O/W) diluted systems where minimal interactions between the droplets were assumed and meaningful results could be obtained.

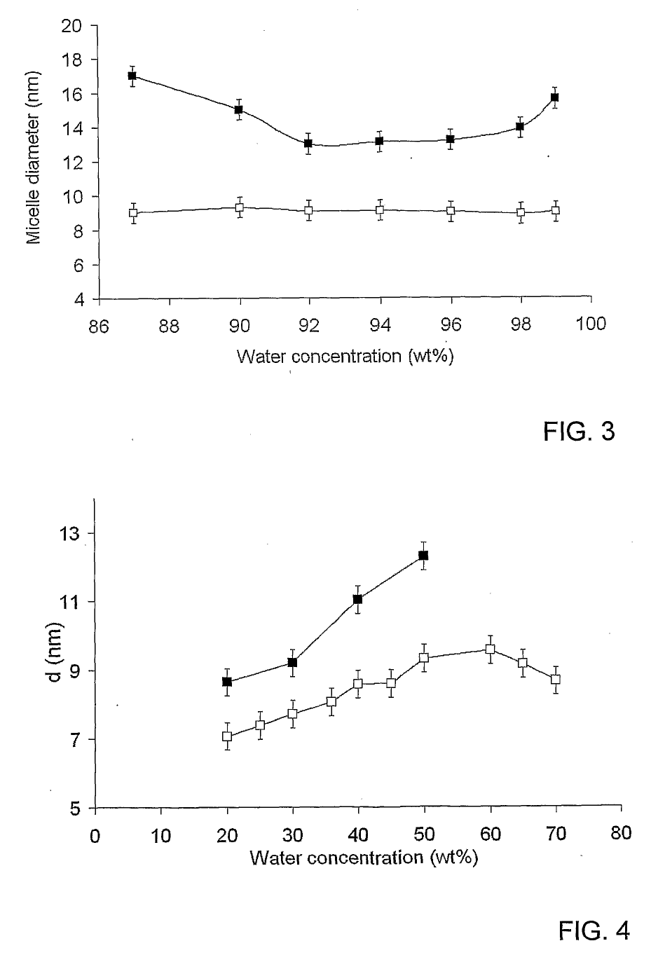

FIG. 3 demonstrates the variability in diameters of the oil-in-water droplets in empty capsules of the microemulsions and those loaded with HPN-68. The droplets grew from 9 nm in empty capsules to 15-18 nm in HPN-68 solubilized microemulsion.

Microemulsion size domains and structural characteristics with increasing water content (20-70 wt %) were measured by small angle X-ray scattering (SAXS). From the Teubner and Strey model [Ref. e] periodicity (d) as a function of water content, was calculated as shown in FIG. 4. It can be seen that for the empty microemulsion, there is a constant increase in the periodicity upon water dilution up to 50 wt %. The water addition causes swelling of the aqueous domains and enlarges the distance between the oil domains until the oil concentration drops. Then the periodicity refers to the droplet size and not to the distance between them. Periodicity increases up to 50 wt % water, where it reaches its maximum, and then drops. Finally, after 70 wt %, the characteristic microemulsion peaks disappear.

Apparently at 65-70 wt % water, the bicontinuous structures transform into O/W microemulsion droplets, where the interface turns out to be convexed toward the oil phase and the surfactant tails are more tightly packed. Assuming that at very low oil content the periodicity can be interpreted as droplet size (beyond 60 wt % water) the microemulsion size domains are 9 nm. The same result was obtained by QELS analysis. In the loaded microemulsion, the HPN-68 solubilization caused an increase in periodicity, compared to the empty one. The hydrophilic guest molecule is accommodated at the interface and in the aqueous phase, and causes additional swelling. The QELS and SAXS results clearly demonstrate that the nucleator can be solubilized in the microemulsion, causing some structural rearrangements, while retaining its nanometric size range.

To analyze the nucleating efficiency of the method of the invention, the self-nucleation process of pure polymer was also studied. Fillon et al. [Refs. f and g] have introduced a method to determine nucleation efficiency of an additive based on the assumption that the self-nucleation procedure allows obtaining the highest achievable crystallization temperature. Thus, the crystallization temperature of a non-nucleated polymer is considered as the lower boundary, and of the self-nucleated polymer as the upper boundary, of the nucleation efficiency scale. Efficiency of heterogeneous nucleation, induced by adding the nucleating agent would lie between that of the homogeneous nucleation and self-nucleation. According to this scale, the best nucleators reported for i-PP have efficiencies in the 50-66% range. Self-nucleation measurements can be carried out in DSC by using four thermal steps that refer to (1) erasure of previous thermal history by heating the sample to 180° C. and maintaining it at this temperature for 5 minutes; (2) creation of the “standard” crystalline state by cooling the polymer to 50° C. at 5° C./min, where the lowest crystallization temperature (T_{c1}) is obtained at this stage; (3) heating the sample to partial melting at temperature (Tₛ), located within the melting range, and holding it there for five minutes (this is the most important step in the procedure); and (4) dynamic crystallization by cooling the sample at 5° C./min.

The nucleating efficiency is calculated according Eq. (1):

$$NE \% = 100 \% \frac{{T}_{cNA} - {T}_{{c}_{1}}}{{T}_{{c}_{2}} - {T}_{{c}_{1}}} \qquad Eq . ( 1 )$$

where T_{cNA}, T_{c1} and T_{c2} are peak crystallization temperatures of the nucleated, non-nucleated, and self-nucleated polymer, respectively.

TABLE 1
Crystallization temperature of the polymer (T_{c}, ±1° C.) as a function
of the preselected temperature, Tₛ (range of 150-160° C.), at which the
PP was partially melted.

| | T_{c} (° C.) at cooling rate | Crystallization |
|---|---|---|
| Tₛ (° C.) | of 5° C./min | enthalpy (J/g) |
| 150 | 127.2 | 33 |
| 152 | 128.0 | 63 |
| 155 | 122.6 | 68 |
| 160 | 105.1 | 68 |

The results listed in Table 1 show the dependence of the polymer crystallization temperature on the pre-selected temperature, Tₛ (within the range of 150-160° C.), at which the polymer was partially melted. Considering the fact that the melting temperature of the polymer is 145° C., the choice of Tₛ below 150° C. would lead to annealing. Conversely, the choice of Tₛ above 160° C. would lead to full melting, without leaving any available crystal fragments, which are required for self-nucleation. The proper choice of Tₛ is critical for self-nucleation temperature determination. Slight variations of Tₛ cause drastic changes in the self-nucleation temperature. At a cooling rate of 5° C./min, the highest obtained crystallization value (T_{c2}) is 128° C., which is taken as the self-nucleation temperature.

Considering that the non-nucleated PP crystallization temperature is 104° C., the nucleating efficiency of an additive can be estimated. To study the effect of the nucleating agent dispersion by the method of the invention, the loaded microemulsion with HPN-68 was introduced to the Haake mixer immediately after the copolymer reached its melting state. Upon introduction of the microemulsion to the molten PP, the water phase vaporized and the blends were mixed for 10 minutes at 50 rpm. Control trials were performed with HPN-68 powder, premixed with the polymer beads before loading the mixer. As shown in Table 2, the experiments showed a dramatic improvement of 24% in the nucleating efficiency (NE) of HPN-68, using the technology of the present invention.

TABLE 2
Dependence of the nucleating efficiency (NE, ±4%) of HPN-68 on its
incorporation method.

| | T_{c} (° C.) at | |
|---|---|---|
| Concentration of HPN-68 | cooling rate | |
| in the PP matrix (ppm) | of 5° C./min | NE (%) |
| 0 | 104 | 0 |
| 600 ppm via powder | 114 | 42 |
| 250 ppm via microemulsion | 120 | 66 |

Note:
The microemulsion contains 50 wt % water (dilution line 82) and 0.96 wt % HPN-68.
The amount of microemulsion (wt %) of the total microemulsion + PP is 3 wt %.

HPN-68 showed only 42% NE when introduced directly via powder both at 300 (not shown) and 600 ppm, both within the range of its minimal working concentrations. When in a microemulsion, only 250 ppm nucleator were required to increase the NE.

Nucleation efficiency of HPN-68 was also tested by preparing the blend of the polymer beads with the microemulsion containing HPN-68 at room temperature before loading it to the mixer. The goal of these trials was to examine if the absorption interaction of the microemulsion with the porosive PP beads before its melting would exhibit an advantage over the “melt introduction” method, which was used earlier. The difference between the two approaches is the primary interaction of the polymer and the microemulsion. In the melt method the aqueous phase of the microemulsion evaporated immediately upon its titration into the molten matrix at 180° C. In comparison, preparing the PP and microemulsion blends allowed absorption interaction between them at room temperature and subsequent heating during 3 minutes in the mixer until the matrix reached full melting. The next dispersing step in the mixer was the same for the two methods.

These two incorporation approaches were compared with HPN-68 dispersion via water solutions that were titrated on the PP beads before loading it to the mixer. A comparison of the PP crystallization temperatures, accomplished by the three methods (Table 3), demonstrates that both microemulsion loading methods have almost the same efficiency. It is apparent that the primary interaction between the microemulsion and the polymer has insufficient impact on the polymer crystallization temperatures. The decisive step is the dispersion in the mixer, which is invariant for the two methods.

TABLE 3
Crystallization temperature of the polymer (T_{c}) as a function
of the incorporation approach.

| Concentration of | T_{c} (° C.) of | T_{c} (° C.) of | T_{c} (° C.) of |
|---|---|---|---|
| HPN-68 in the PP | the PP | the PP | the PP |
| matrix (ppm) | via Method 1 | via Method 2 | via Method 3 |
| 100 | 114.6 | 115.6 | 108.6 |
| 300 | 115.0 | 116.6 | 109.3 |

Method 1: Incorporation of HPN-68 via microemulsion by melt introduction.
Method 2: Incorporation of HPN-68 via microemulsion by preparing the blend of the polymer beads with the microemulsion in advance.
Method 3: Incorporation of HPN-68 via water solution.
Note:
The microemulsion formulation contains 50 wt % water (dilution line 82) and 0.96 wt % HPN-68.
The amount of microemulsion (wt %) of the total microemulsion + PP is 3 wt %. The DSC scanning rate is 10° C./min.

Table 3 also reveals that the nucleator dispersion via microemulsion was much more effective than via water solution. Although the water solution can disperse the nucleator at the molecular level, it cannot offer any better transport ability in the hydrophobic polymeric matrix as does the surfactant.

The microemulsions of the invention were tested as nucleating agents in very low concentrations not only in order to achieve higher crystallization temperatures, but also to reach them at minimum nucleator concentrations. Such a possibility would allow saving the costs associated with the nucleating agent, to cheapen the production processes and even to make the use of the nucleator more effective.

Within the scope of the study leading to the present invention, the following experiments were conducted: nanosized self-assembled structured liquids (NSSL) (dilution line 82) containing 50% water were introduced to the target molten thermoplastic polymer of random copolymer of polypropylene Capylene QT 73 (45 gr). and 1500 ppm of Irganox antioxidant, using Haake mixer at 180° C., during 12 minutes, 2 first minutes at 10 rpm and 10 minutes at 50 rpm.

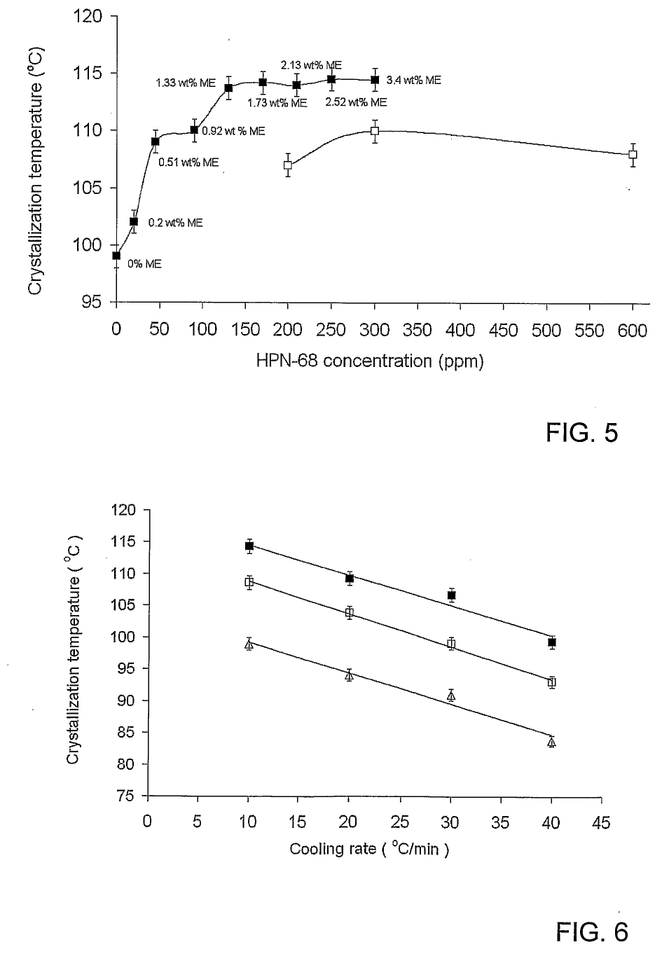

FIG. 5 shows a consistent increase in PP crystallization temperature as a function of HPN-68 and surfactant concentration (at cooling rate of 10° C./min). At 200 ppm the nucleating agent reached its supersaturation state in this system resulting in the highest crystallization temperature (114° C.); this did not change sufficiently upon increasing the nucleator concentration. One may note that in order to achieve the highest T_{c} similar to the one obtained by adding 300 ppm of a dispersed nucleator powder (108° C.), only 50 ppm of nucleator are sufficient. In other words, five-times less nucleating agent is required. Introduction of non-capsulated nucleator at such low concentrations generates inconsistent results in the matrix crystallization temperature due to improper dispersion ability (data not shown). In contrast, the microemulsion approach allows obtaining a consistent correlation between the PP crystallization temperatures as a function of the nucleator content, as shown in FIG. 5.

At non-isothermal crystallization conditions, it is very important to obtain high PP crystallization temperatures at high cooling rates for industrial applications. FIG. 6 shows PP crystallization temperatures as a function of the cooling rate. Within each curve the differences between crystallization temperatures are results of the heat dissipation ability: fast cooling causes low crystallization temperatures. The differences between the curves indicate the nucleating efficiency of the microemulsion and conventional approaches compared with the non-nucleated PP. It is easily seen that introduction of HPN-68 via microemulsion is advantageous at high cooling rates as well. It should be noted that the slopes of the curves have almost the same value. It is evident that despite the finer dispersion ability of the microemulsion technology, introduction of the microemulsion does not affect the heat dissipation during PP crystallization.

Another kinetic parameter that corresponds to nucleating agent efficiency is its ability to decrease the activation energy (ΔE) of crystallization. Considering the influence of the various cooling rates on the nonisothermal crystallization process, the Kissinger model [Ref. h] can be used to determine the activation energy by calculating the variation in crystallization temperature (Tₚ) with the cooling rate (Φ):

$$\frac{d [ ln ( \frac{Φ}{{T}_{p}^{2}} ) ]}{d ( \frac{1}{{T}_{p}} )} = - \frac{Δ E}{R} \qquad Eq . ( 2 )$$

where R is the gas constant.

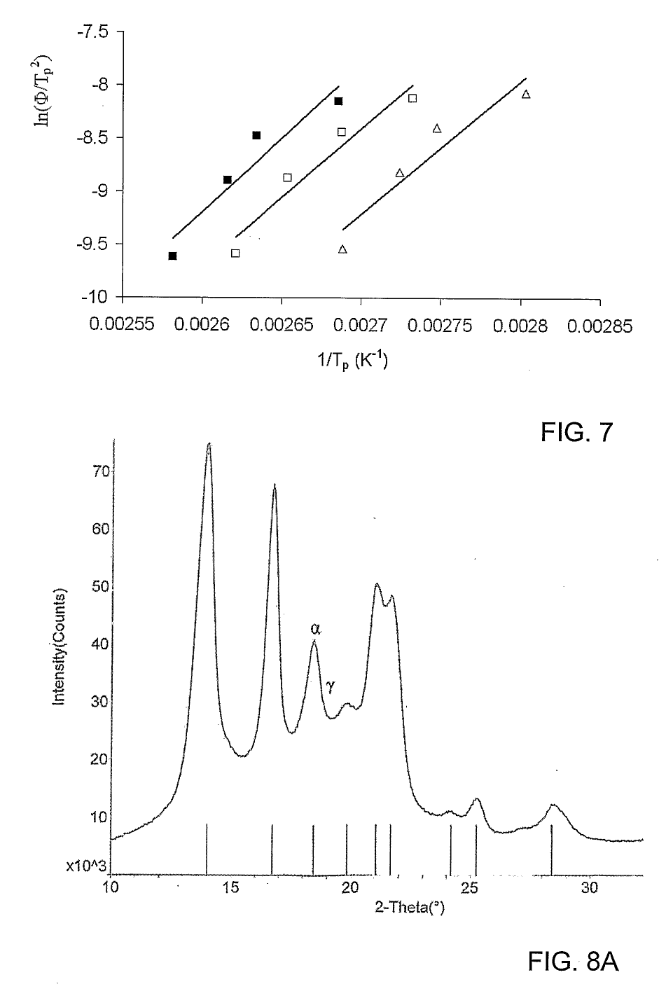

FIG. 7 shows the graphs of ln(Φ/Tₚ²) vs. 1/Tₚ. The slope of the curve determines the (−ΔE/R). The activation energy, ΔE, was found to have the lowest value (−115.1 kJ/mol) for HPN-68 microemulsion dispersion, as compared with conventional dispersion (−107.1 kJ/mol) and a non-nucleated sample (−104.5 kJ/mol). This result indicates that PP crystallization via the microemulsion technology is energetically favored and therefore increases the rate of PP crystallization

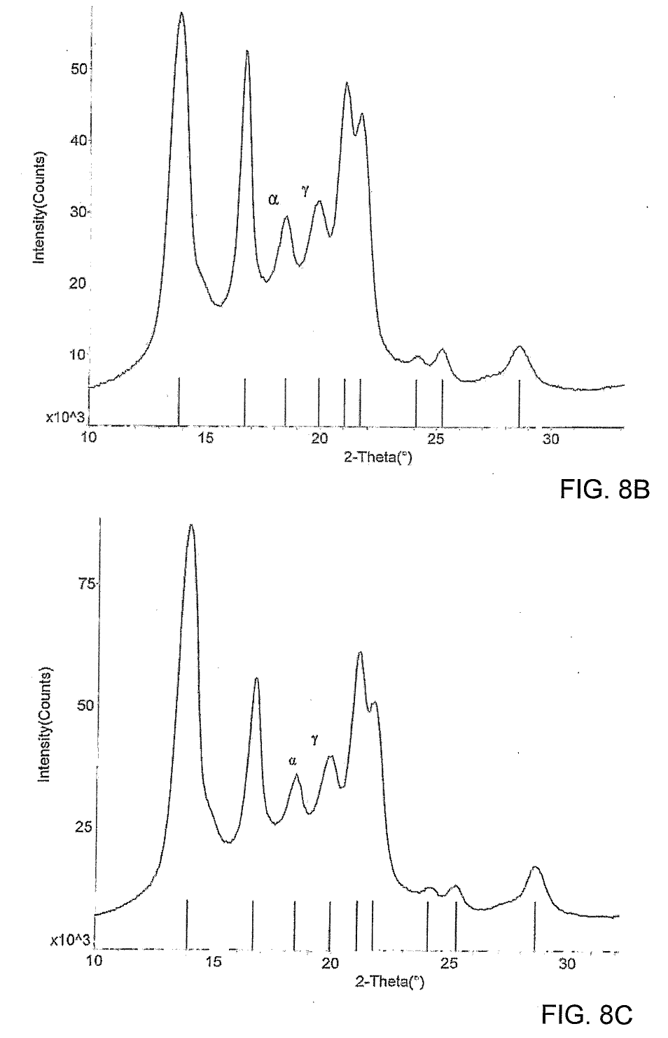

Wide-angle X-ray scattering (WAXS) analysis was performed to relate the crystalline structure of the polymer to the nucleating agent impact. Variations in positions and intensities of the diffraction peaks can indicate different crystal modifications. WAXS patterns are presented in FIGS. 8A to 8C. All three patterns showed characteristic peaks of α-crystal modification: 13.9° (110), 16.7° (040), 18.5°(130), 21.0° (111), 21.7° [(041) and (−131)], 25.25° (060), 28.6° (220), and γ-modification—19.9° (130). According to the characteristic γ-peak (130), γ-crystal modification was identified in the copolymer. In many cases, γ-phase initiation in i-PP is a result of isotacticity decrease, which is caused by steric irregularities or copolymerization with ethylene. Large contents of the γ-phase are obtained when i-PP is crystallized at elevated pressures, when very low molecular weight samples (between 1,000 and 3,000 g/mol) are used, or when crystallization takes place at elevated temperatures. Slow melt crystallization also can initiate γ-phase formation. Turner-Jones [Ref. i] showed that the amount of the γ-phase in i-PP samples also containing the α-phase, X_{γ}, can be calculated from the ratio of the heights of the peaks at 18.5° (130) of the α-modification and at 19.90 (130) of the γ-modification:

$${X}_{γ} = \frac{{I}_{γ ( 130 )}}{{I}_{γ ( 130 )} + {I}_{α ( 130 )}} \qquad Eq . ( 3 )$$

It is evident from the WAXS profiles (FIG. 8A-C), that the α-modification is present together with the γ-modification. An increase in the peak intensity of the γ-form crystalline reflection can be observed in nucleated PP profiles, compared with non-nucleated ones. The Turner-Jones procedure gives a value of about 6% γ-form in non-nucleated PP, an increased percentage of 44% γ-form in PP nucleated via BPN-68 powder, and 49% γ-form in PP nucleated via microemulsion technology. Without wishing to be bound by a theory or any specific theoretical explanation, in this case, it can be concluded that γ-phase formation is due to short ethylene segments present in the copolymer, which results in a decrease in isotactisity. The short copolymer segments are not able to organize themselves into a perfect structure but exhibit only short-range order and seem to promote γ-phase formation. From the results obtained, it is worth emphasizing that HPN-68 is a γ-nucleator resulting in polymorphic behavior by sufficient increase in the γ-modification.

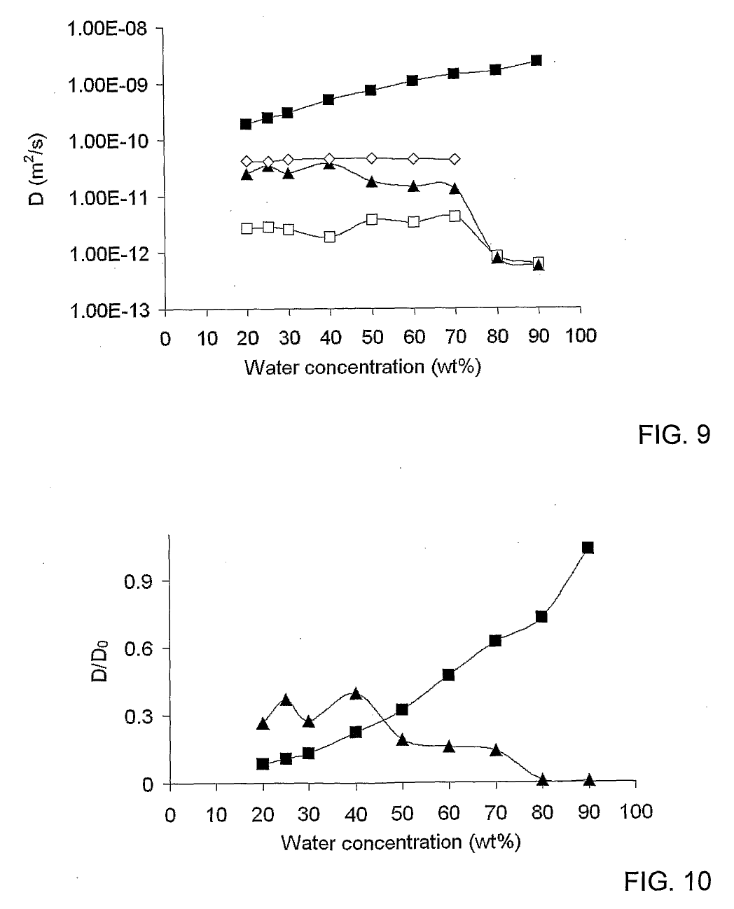

Pulsed field gradient spin echo NMR(PGSE-NMR or SD-NMR) is a well-established technique to determine diffusion coefficients of microemulsion components. Fast diffusion (>10⁻⁹ m²s⁻¹) is characteristic of free molecules in solution while a small diffusion coefficient (<10.12 m²s⁻¹) suggests the presence of macromolecules or immobilized (or bound) molecules. The self-diffusion coefficients are often used to distinguish between W/O, bicontinuous, and O/W microemulsions. Dₒ^{water} and Dₒ^{oil} denote the diffusion coefficients of the free molecules of water and oil in pure solvent, respectively. D_{water}, Dₒᵢₗ, D^{Surfactant}, and D^{Alcohol} denote the diffusion coefficients of water, oil, surfactant, and alcohol in the microemulsions. In a typical O/W microemulsion, the sequence is D^{Oil}<<D^{water} (10⁻¹¹ vs 10⁻⁹ m²s⁻¹, respectively). In a typical W/O microemulsion, the order will be D^{water}<<D^{Oil}, while in the bicontinuous phase, both D^{water} and D^{Oil} are high (in the order of 10⁻⁹ m²s⁻¹) and quite similar. The behavior of the microemulsions and the diffusion coefficients of each of the microemulsion components was examined in the presence of the maximum amount of solubilized nucleating agent. FIG. 9 shows the absolute diffusion coefficient values of each phase in the empty microemulsion. As could be understood from the dependence of the diffusion coefficient as a function of water concentration shown in FIG. 9, the diffusion coefficients of the oil are two orders less than those of water along the whole region of 20-90 wt % water. This fact supports the existence of the two-dimensional structure along dilution line 82 in the empty system. In such microstructure, the oil mobility is severely restricted by the lipophilic chains of the surfactant that are very tightly packed. In fact, the oil phase is entrapped in a cylinder and its mobility is restricted along the cylinder. Normally, a bicontinuous structure exists when the concentrations of the oil and the water are quite similar. In the system of the present invention, this situation does not occur. The 1:2 ratio of the oil to 1-hexanol and dilution line 82, implies that the maximum oil content of ˜6.7 wt % (at 0 wt % water concentration) progressively decreases along the dilution line.

The bicontinuous structure cannot exist at such low oil and such high surfactant concentrations. This conclusion is supported by the results shown in FIG. 10. The diffusion coefficients of the water and the oil were normalized to the values measured for pure water and pure oil and plotted against the aqueous phase content in an empty microemulsion. One can see that in the region between 20-60 wt % water, D^{Oil}/Dₒ^{oil}˜0.2-0.3. These are very low values for a solvent that is supposed to be in the continuous phase for a bicontinuous structure to occur. Such values are more appropriate for a two-dimensional, worm-like microstructure. For the water, D^{water}/Dₒ^{water} progressively increases and eventually reaches values close to the neat liquid.

The transition from the worm-like phase to O/W droplets can be identified from FIG. 9. When the inversion occurs, the water is slowly released from the bilayer and becomes free in the continuous phase, while the oil is entrapped in the core of the microemulsion. This occurs above 65-70 wt % aqueous dilution, when the diffusion sequence is D^{water}>>D^{Surfactant}™D^{Oil}. Diffusion coefficients of the oil and the surfactant decrease and become equal, indicating the formation of O/W droplets. These results are in conformity with DSC analysis which shows the water transitions along the dilution line from unfreezable bound water to interfacial water and eventually to free water.

The function of the alcohol in the microemulsion can be determined from FIG. 9. It can be seen that it is accommodated much closer to the oil than to the water. 1-Hexanol is a hydrophobic molecule and interacts well with the alkyl chains of the mineral oil. Its role is to stabilize the interaction between the hydrophilic surfactant Tween 60 (via its ethylene oxide units and the hexanol OH functional group) and the highly hydrophobic oil. It allows mutual solubility of the oil phase and the surfactant phase at any ratio, as shown in the phase diagram (FIG. 1). It should be noted that the behavior of 1-hexanol is different from that of short chain alcohols and polyols which are located both at the interface and in the aqueous phase, inducing the formation of both W/O and O/W microemulsions.

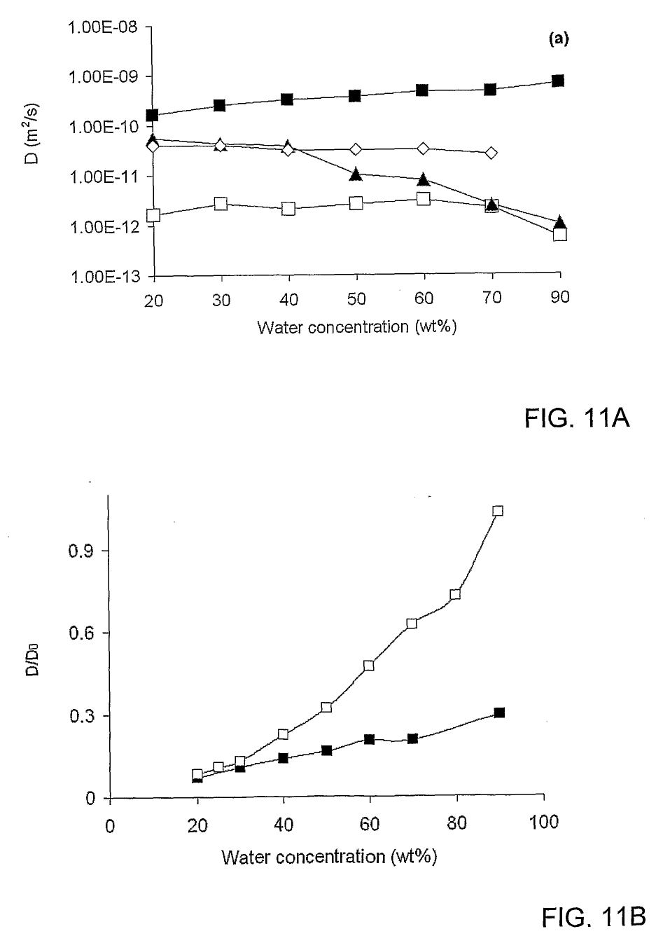

Diffusion coefficient values of each phase in the presence of the nucleating agent are presented in FIG. 11A. The trend in behavior of the surfactant, oil, and alcohol is almost invariant. These results are not surprising since the nucleator is a highly soluble hydrophilic salt (30 wt % solubilization of total water+HPN-68). However, normalized water diffusion coefficients of the loaded system dropped sharply, compared with those of the empty microemulsion as shown in FIG. 11B. The sharp decrease in water mobility suggests that the nucleator is accommodated mostly in the aqueous phase. In the range of 20-30 wt % aqueous phase, the water mobility is almost unaffected, due to low solubilization of the nucleator. Upon further water dilution, HPN-68 solubilization increases and, therefore, the nucleator sufficiently decreases the water diffusion coefficients.

Viscosity depends largely on the microemulsion structure, i.e., the type and shape of aggregates, concentration, and interactions between dispersed particles. Viscosity can, therefore, be used to obtain important information concerning the microstructural transformations in microemulsions.

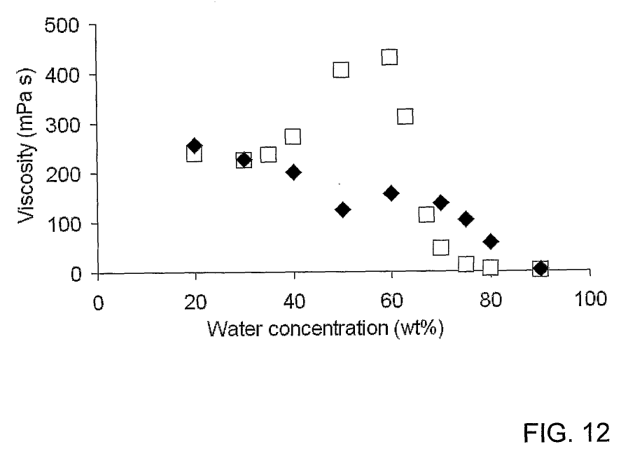

Shear rate versus shear stress curves have been measured along dilution line 82 in empty and loaded microemulsions (data not shown). The shear curves invariably showed Newtonian behavior over the shear range studied, and the viscosity was calculated as derivative of the curves. FIG. 12 shows the variation in viscosity in empty and loaded microemulsions along dilution line 82. One can see a characteristic bell shaped curve of the empty microemulsion. Water dilution causes an increase of viscosity in the worm-like region up to 60 wt %, where it reaches the maximal value of 450 mPa/s. Two-dimensional swelling (as was shown by SAXS measurements) increases molecular interactions and hence increases the viscosity. Beyond 60 wt % water phase, a sudden decrease in viscosity is observed which is correlated to the transition from worm-like structure into an O/W microemulsion. The sharp change in viscosity clearly indicates the inversion of the interface curvature and evolution of O/W droplets which begins in the range of 63-67 wt % water phase. With high water dilution (90 wt % water), the microemulsion viscosity is similar to that of water. Solubilization of the nucleator changes the viscosity behavior from the bell-shaped curve of the empty microemulsion to a progressively decreasing curve of the loaded one.

The decrease in viscosity in the worm-like region is derived from at least two competing factors: (1) the water dilution effect-swelling with water increases the microstructure size and therefore the viscosity increases and (2) in the worm-like region, the nucleator molecules that are probably accommodated at the interface and in the aqueous phase partially break the microstructure. Such guest molecule effect decreases the structure size and hence decreases the viscosity. The influence of the nucleator is more dominant than the water dilution effect (the swelling is only two-dimensional). It should be noted that the viscosity of the loaded O/W microemulsion is higher than the viscosity of the empty one. With the formulation of the O/W microemulsion, the hydrophilic guest molecule increases the size of the micelles, resulting in higher viscosity. This conclusion is confirmed by the QELS results that showed the swelling of the droplets from 9 nm in an empty microemulsion to 15-18 nm in an HPN-68 solubilized microemulsion.

### SPECIFIC NON-LIMITING EXAMPLES

### Example 1

### Phase Diagrams and Solubilization of the HPN-68 Nucleator

The four-component system was described on pseudotemary phase diagrams. It was constructed at ca. 25° C. HPN-68 was solubilized by adding predetermined amounts of water, mineral oil, 1-hexanol, and Tween 60 dropwise to obtain a single phase microemulsion with the desired composition. BPN-68 was then added. The samples were stored at 25° C.

### Example 2

### Introduction of the Nucleator into the Polymer

The nucleator was introduced into the polymeric matrix in a Haake mixer manufactured by Thermo Haake (Karlruhe, Germany). The following procedure was followed: (1) heating 45 gr of the polymer for 2 minutes at a rotor speed of 10 rpm and introduction of the microemulsion containing the nucleator dropwise to the polymer melt; (2) mixing for 10 minutes at 180° C., 50 rpm. An alternative method, premixing the microemulsion with the polymer beads at room temperature, before introduction to the mixer was also used. Non-nucleated polymer and conventionally nucleated PP via HPN-68 powder and water solution (which was premixed with the PP beads at room temperature before introduction to the mixer) were used as the control. Antioxidants Irganox B215 (1,000 ppm) was used in all trials.

### Example 3

### Injection Molding

The samples were injection molded for further analysis in a Battenfeld Injection molding machine 800 CD-plus. Barrel temperature of 220° C. and mold temperature of 30° C. were applied.

### Example 4

### Dynamic Light Scattering (DLS)

The dynamic light scattering equipment consisted of an Argon+laser (wavelength of 514.5 nm). The measurements were carried out at a scattering angle of 90° (q) at 20° C. (T) using an effective laser power of 200 mW and 1 W, depending on the scattering intensity of the samples. Data were collected in repeated measurements of 10-30 seconds each, until a total of 10 million counts were reached or, for the samples containing some very big particles which disturb detection, until at least some of the measured curves were not completely distorted (1-phase channel). The best intensity autocorrelation functions were averaged. Form the DLS experiments, an apparent diffusion coefficient D_{eff} was obtained by means of a second-order cumulative analysis of the intensity autocorrelation function. The apparent hydrodynamic radius R_{H,app} was calculated using Eq. (4):

$${R}_{H , app} = \frac{{k}_{B} T}{6 π η {D}_{eff}} , \qquad Eq . ( 4 )$$

where k_{b} is the Boltzmann constant, T is the absolute temperature, and η is the viscosity of the continuous medium at a given temperature. The effective diffusion coefficient describes the diffusion behavior while the hydrodynamic radius gives a result in terms of a dimension.

### Example 5

### Small Angle X-ray Scattering

Microemulsion samples, prepared as described hereinabove, were investigated by small angle X-ray scattering (SAXS). Scattering experiments were performed using Ni-filtered CuKα radiation (0.154 nm) from Eliott GX6 rotating X-ray generator that operated at a power rating up to 1.36 kW X-radiation was further monochromated and collimated by a single Franks mirror and a series of slits and height limits and measured by a linear position-sensitive detector. The sample was inserted into 1-1.5 mm quartz or lithium glass capillaries. The temperature was maintained at 25±0.5° C. The sample-to-detector distance was 0.46 m.

### Example 6

### X-ray Data Analysis

The SAXS spectra in the monophase region exhibited a single broad maximum at q#0 followed by a monotonic decrease of the scattered intensity I(q) at large values of the wave vector amplitude q (q=(4πλ)sin θ, where 2θ is the scattering angle and λ=1.54 Å for Cu radiation). The scattering patterns after appropriate background correction were fit to Eq. (5)

$$I ( q ) = \frac{1}{( {a}_{2} + {q}^{2} {c}_{1} + {q}^{4} {c}_{2} )} + b \qquad Eq . ( 5 )$$

with the constants a2, c1, c2 obtained by using the Levenburg-Marquart procedure. Such a functional form is simple and convenient for the fitting of spectra. The following Eq. (6) corresponds to a real space correlation of the form:

$$v ( r ) = \frac{sin kr}{kr} {e}^{- r / ξ} \qquad Eq . ( 6 )$$

The correlation function describes a structure with periodicity d=2πk damped as a function of correlation length ξ. This formalism also predicts the surface to volume ratio, but because this ratio is inversely related to the correlation length and therefore must go to zero for a perfectly ordered system, calculated values are frequently found to be too low. The values d and ξ are related to the constants in Eqs. (7) and (8):

$$\begin{matrix}K = {[ \frac{1}{2} {( \frac{{a}_{2}}{{c}_{2}} )}^{1 / 2} - \frac{{c}_{1}}{4 {c}_{2}} ]}^{- 1 / 2} , & Eq . ( 7 ) \\ ξ = {[ \frac{1}{2} {( \frac{{a}_{2}}{{c}_{2}} )}^{1 / 2} + \frac{{c}_{1}}{4 {c}_{2}} ]}^{- 1 / 2} . & Eq . ( 8 )\end{matrix}$$

### Example 7

### Differential Scanning Calorimetry (DSC) Measurements

The PP nonisothermal crystallization kinetic was carried out on a Mettles Toledo DSC 822 differential scanning calorimeter under a nitrogen purge. The following procedure was followed: (a) first heating run at 10° C./min up to 180° C.; (b) maintaining the temperature at 180° C. for 5 minutes; (c) cooling to room temperature at 10 or 5° C./min (for estimating nucleation efficacy); and (d) second heating run, at 10° C./min up to 180° C.

The microemulsion DSC measurements were carried out as follows: samples (5-15 mg) were weighed using a Mettler M3 Microbalance in standard 40-ml aluminum pans and immediately sealed by a press. All DSC measurements were performed in the endothermic scanning modes (i.e., controlled heating of previously frozen samples). The samples were rapidly cooled by liquid nitrogen at a pre-determined rate from 30 to −100° C., kept at this temperature for 30 minutes, and then heated at a constant scanning rate (5° C./minute) to 90° C. All experiments were replicated at least three times.

### Example 8

### Wide-angle X-ray Scattering (WAXS)

WAXS analysis of the examined materials (samples that were injection molded earlier) was performed at room temperature using goniometer Rigaku D-Max and generator Rigalu-Ru-200 operating at 150 kV and 50 mA. The scans were performed within the range of 2θ=10-35° with scanning step of 0.05° at a rate of 11/min.

### Example 9

### Scanning Electron Microscope (HR-SEM)

An HR-SEM Sirion scanning electron microscope was used to study the morphology. The PP specimens were etched before examination. The samples were covered with gold using SC7640 Sputter before being examined with the microscope.

### Example 10

### PGSE-NMR (Pulsed Gradient Spin Echo-NMR)

NMR measurements were performed on microemulsion samples at 25° C. on a Bruker DRX-400 spectrometer, with BGU-II gradient amplifier unit and 5-mm BBI probe equipped with z-gradient coil, providing a z-gradient strength (g) of up to 55 G/cm. The self-diffusion coefficients were determined using pulsed field gradient stimulated spin echo (BPFG-SSE). All experiments were replicated three times.

### Example 11

### Viscosity Measurements

Rheological measurements were performed at 25° C. on samples along the dilution line 82. The measurements were made on a Thermo Haake RheoScopel rheometer using cone (6 cm in diameter, 1 grad angle) and plate geometry with 0.022 mm gap. Shear rate was between 10 and 1000 s¹. All experiments were replicated three times.

1. A nucleating microemulsion comprising a plurality of nanovehicles, each having an amphiphilic shell substantially surrounding at least one nucleator.

2. The nucleating microemulsion according to claim 1, wherein said at least one nucleator is solubilized in a system of water, oil, alcohol and at least one amphiphile.

3. The nucleating microemulsion according to claim 1, wherein said at least one nucleator is hydrophilic or hydrophobic.

4. The nucleating microemulsion according to claim 1, wherein said at least one nucleator is selected from metal salts of organic acids or phosphonic acids.

5. The nucleating microemulsion according to claim 4, wherein said at least one nucleator selected from metal salts of organic acids is selected amongst salts of benzoic acid, alkyl substituted benzoic acid derivatives, bicyclo [2.2.1]heptane dicarboxylate, 1,3-O-2,4-bis(3,4-dimethylbenzylidene)sorbitol, 1,3-0-2,4-bis(p-methylbenzylidene)sorbitol, sodium 2,2′-methylene-bis-(4,6-di-tert-butylphenyl)phosphate, and aluminum bis[2,2′-methylene-bis-(4,6-di-tert-butylphenyl)phosphate] with lithium myristate.

6. The nucleating microemulsion according to claim 5, wherein said at least one nucleator is bicyclo [2.2.1]heptane dicarboxylate salt (HPN-68).

7. The nucleating microemulsion according to claim 1, wherein said at least one nucleator resides in the core of the nanovehicle, between the amphiphilic molecules forming the shell or on the outer perimeter of the shell.

8. The nucleating microemulsion according to claim 1, wherein said amphiphilic shell comprises at least one amphiphile.

9. The nucleating microemulsion according to claim 8, wherein said amphiphile is at least one surfactant.

10. The nucleating microemulsion according to claim 9, wherein said at least one surfactant is ionic, non-ionic or zwitterionic.

11. The nucleating microemulsion according to claim 10, wherein said surfactant is a nonionic surfactant having a hydrophilic-liphophilic balance (HLB) value in the range of 9-16.

12. The nucleating microemulsion according to claim 10, wherein said amphiphile is selected from sodium dodecyl sulphate, benzalkonium chloride, cocamidopropyl betaine, octanol, poryoxyethylene-20-sorbitan monostearate (Tween 60), polyoxyethylene-20-sorbitan monooleate (Tween 80), polyoxyethylene-20-sorbitan monolaurate (Tween 20), polyoxyethylene-20-sorbitan monomyristate (Tween 40), polyoxyethylene-9 nonyl phenol ether, polyoxyethylene-12-nonyl phenol ether, polyoxyethylene-15-nonyl phenol ether, ethoxylated-10-lauryl alcohol, ethoxylated-20-oleyl alcohol, ethoxylated-15-stearyl alcohol, ethoxylated-20-castor oil, hydrogenated ethoxylated-25-castor oil, and combinations thereof.

13. (canceled)

14. The nucleating microemulsion according to claim 12, wherein said amphiphile is polyoxyethylene-20-sorbitan monostearate (Tween 60).

15. The nucleating microemulsion according to claim 1, wherein said at least one hydrophilic nucleator is bicyclo [2.2.1]heptane dicarboxylate salt (HPN-68) and the at least one amphiphile is polyoxyethylene-20-sorbitan monostearate (Tween 60).

16. The nucleating microemulsion according to claim 1, wherein each of said plurality of nanovehicles has a cross-sectional average diameter of the nanometer scale.

17-18. (canceled)

19. The nucleating microemulsion according to claim 1 further comprising at least one additive selected amongst co-solvents, co-surfactants, colorants, pigments, perfumes, carbon black, glass fibers, fillers, impact modifiers, antioxidants, stabilizers, flame retardants, reheat aids, anticaking agents, antistatic agents, ultraviolet absorbers, acetaldehyde reducing compounds, acid scavengers, antimicrobials, light stabilizers, recycling release aids, plasticizers, mold release agents, compatibilizers and any combination thereof.

20. The nucleating microemulsion according to claim 1, wherein said oil is a water-immiscible liquid.

21. The nucleating microemulsion according to claim 2, wherein said oil is selected from mineral oil, paraffin oil, xylene, toluene, petroleum ether, hexanes, decalin, isopropylmyristate, medium chain triglycerides, dodecane, tetradecane, and hexadecane.

22. The nucleating microemulsion according to claim 21, wherein said oil is a liquid mineral oil in the work region of temperature 10-120° C.

23. The nucleating microemulsion according to claim 22, wherein said oil is Marcol 52.

24. The nucleating microemulsion according to claim 2, wherein said at least one hydrophilic nucleator is bicyclo [2.2.1]heptane dicarboxylate salt (HPN-68) and the at least one oil is Marcol 52.

25. The nucleating microemulsion according to claim 2, wherein said at least one hydrophilic nucleator is bicyclo [2.2.1]heptane dicarboxylate salt (HPN-68), the at least one amphiphile is polyoxyethylene-20-sorbitan monostearate (Tween 60) and the at least one oil is Marcol 52.

26. The nucleating microemulsion according to claim 2, wherein said alcohol is selected from pentanol, butanol, octanol, decanol, hexylene glycol, propylene glycol, isopropanol. propanol, dodecanol, 1-heptanol, 2-heptanol, 3-heptanol, 2-hexanol, 3-hexanol, 1-methyl, butanol, 1-methylpentanol, 1-methylhexanol, 1-methylheptanolanol, 4-ethyl-1-propanol, 2-methylbutanol, 3-methylhexanol, 2-methylpentanol, cyclohexanol and any combination thereof.

27. The nucleating microemulsion according to claim 26, wherein said alcohol is 1-hexanol.

28. The nucleating microemulsion according to claim 1, being suitable for the delivery of at least one nucleator into a thermoplastic polymer.

29. The nucleating microemulsion according to claim 28, wherein said thermoplastic polymer is a combination of at least two thermoplastic polymers.

30. The nucleating microemulsion according to claim 28, wherein said thermoplastic polymer is a polyolefin.

31. The nucleating microemulsion according to claim 30, wherein said polyolefin is selected from functionalized or non-functionalized polypropylene, isotactic or syndiotactic polypropylene, functionalized or non-functionalized polyethylene, functionalized or non-functionalized styrenic block copolymers, styrene butadiene copolymers, ethylene ionomers, styrenic block ionomers, polyurethanes, polyesters, polycarbonate, polystyrene, low density polyethylene, linear low density polyethylene, medium density polyethylene, high density polyethylene, polypropylene, polyamide, poly(m-xyleneadipamide), poly(hexamethylenesebacamide), poly(hexamethyleneadipamide), poly(epsilon-caprolactam), polyacrylonitriles, polyester, poly(ethylene terephthalate), polylactic acid, polycaprolactone, alkenyl aromatic polymers, polystyrene, and mixtures or copolymers thereof.

32-33. (canceled)

34. A nanovehicle comprising an amphiphilic shell and at least one nucleator.

35. A nanovehicle according to claim 34, suitable for delivering at least one nucleator into a thermoplastic polymer.

36. A method for the crystallization of a thermoplastic polymer comprising dispersing a nucleating microemulsion of a plurality of nanovehicles in a thermoplastic polymer at the molten state, wherein each of said plurality of nanovehicles comprises at least one nucleator.

37. The method according to claim 36, wherein said crystallization involves one or more of the following: induction of crystallization of the polymer from the molten state, enhancement of initiation of polymer crystallization sites, speeding up of crystallization of the polymer, increasing the effectiveness of nucleation sites, increasing crystallization rate, increasing crystal propagation, and enhancement of crystallization relative to crystallization using non-capsulated nucleators.

38. The method according to claim 37, wherein said nucleating microemulsion is added to the thermoplastic polymer at the melting temperature of the polymer.

39. The method according to claim 37, wherein said nucleating microemulsion is added to the thermoplastic polymer at a temperature below the melting temperature of the polymer.

40. A method of increasing the nucleation efficiency of a thermoplastic polymer comprising dispersing a nucleating microemulsion of a plurality of nanovehicles in a thermoplastic polymer at the molten state, wherein each of said plurality of nanovehicles comprises at least one nucleator.

41. The method according to claim 36, wherein said nucleator is added in a concentration between about 20 ppm to about 200 ppm.

42. The method according to claim 41, wherein said nucleator is added in a concentration between about 20 ppm to about 100 ppm.

43. The method according to claim 41, wherein said nucleator is added in a concentration between about 20 ppm to 50 ppm.

44. A method for preparing a nucleating microemulsion having a plurality of nanovehicles, said method comprising: i. obtaining a microemulsion of a plurality of nanovehicles each having an amphiphatic shell, and ii. admixing into said microemulsion at least one nucleator, thereby obtaining a nucleating microemulsion having a plurality of nanovehicles, each comprising at least one nucleator.

45. A method of producing an isotropic thermoplastic polymer comprising:
i. dispersing a nucleating microemulsion of a plurality of nanovehicles in a thermoplastic polymer at the molten state; and
ii. cooling the resulting molten thermoplastic polymer, thereby obtaining the isotropic thermoplastic polymer; wherein each of said plurality of nanovehicles of step (i) comprises at least one nucleator solubilized in a system of water, oil, alcohol and at least one amphiphile.

46. A thermoplastic article obtained by a method of crystallization of at least one thermoplastic polymer, said method comprises:
i. dispersing a nucleating microemulsion of a plurality of nanovehicles in a thermoplastic polymer at the molten state; and ii. cooling the resulting molten thermoplastic polymer;
iii. optionally molding the resulting thermoplastic polymer into a desired shape;
wherein each of said plurality of nanovehicles of step (i) comprises at least one nucleator solubilized in a system of water, oil, alcohol and at least one amphiphile.

47-51. (canceled)
